(19) United States
(12) Patent Application Publication
(10) Pub. No.: US 2004/0044429 A1
(43) Pub. Date: Mar. 4, 2004

(54) Optimal section setting program

(76) Inventors: Makoto Takeda, Shinjuku-ku (JP); Masaharu Takayama, Shinjuku-ku (JP); Tomoki Mizobuchi, Shinjuku-ku (JP); Hiroshi Hirayama, Shinjuku-ku (JP); Junichi Fukushima, Shinjuku-ku (JP); Shoji Iijima, Shinjuku-ku (JP); Chikao Hishinuma, Shinjuku-ku (JP)

Correspondence Address: WENDEROTH, LIND & PONACK, L.L.P., 2033 K STREET N. W., SUITE 800, WASHINGTON, DC, 20006-1021, US

(21) Appl. No.: 10/228,101

(22) Filed: Aug. 27, 2002

(51) Int. Cl. G06F 19/00

(52) U.S. Cl. 700/97

(57) ABSTRACT

An optimal section setting program capable of setting in a short time and with accuracy an optimal section having a desired strength at the minimum cost without depending on skill of a designer is provided. A computer performs: an initial value setting step 1 for selecting under an initial condition of an inputted building as initial values materials and sections of the lowest and highest floors in a similar building whose materials and sections are stored in the database in advance; a vertical group setting step 2 for setting between the lowest and highest floors plural vertical groups including one or more floors in which materials and sections are identical; a vertical variation step 3 for setting plural examination groups of combinations of plural sections and plural materials for each vertical group so that the sections and the materials of the lowest and highest floors would be changed at a certain ratio; a structural calculation step 4 for performing structural calculation for each of the plural examination groups; a cost calculation step 6 calculating a cost after performing quantity calculation 5 based on respective sections and materials of the plural examination groups; and a minimum cost determining step 7 for determining a minimum cost based on results of the calculation at the cost calculation step.

### BACKGROUND OF THE INVENTION

1. Field of the Invention

The present invention relates to a program for setting an optimal section of a skeleton from a bottom floor to a top floor of a structure in reinforced concrete construction.

2. Description of the Related Art

Generally, in setting an optimal section of a building construction member for constructing a building in reinforced concrete construction, structural calculation is first carried out on the basis of a prerequisite condition such as a profile and specification of a building so as to determine sections of columns, girders and earthquake resistant walls, and materials such as class, strength of concrete and reinforcing bars, and then, to separately calculate a cost on the basis of a result of the above determination.

In selecting an optimal section of the members of the above building construction, it has been conventionally considered that the fewer the members, the more optimal the sections of the members (minimum gravimetric method). On the other hand, a skilled designer determines according to his or her experience whether the selected section is optimal or not, and when it is determined to be unsuitable, for example, an assumed section is reviewed to carry out structural calculation repeatedly.

There has been, however, a problem pointed out such that as for the above minimum gravimetric method, which is a point of reference for an optimal section of a building construction member, the quantity with the minimum gravity is not necessarily directed to a minimum cost, depending on a manner of combining materials. Moreover, performing the examination for setting a section on the basis of several examples results in limitation of examples for examination, and therefore, it is not assured that combination of a section of a member and a material is optimal when a general judgment is performed with a cost being taken into account.

In addition, the judgment whether a section of a member is optimal or not also exclusively depends on skill and experience of a designer, and there is no criterion of objective judgment.

Further, the above structural calculation should be repeated when it is judged that the once determined section is unsuitable in view of a cost, so that there would be a serious problem such that greatly much labor and time are required.

On the other hand, there has been recently developed various kinds of structural calculation program for proportioning a section in selecting a section of a member of a structure by assuming a section of a construction member so as to calculate weight and rigidity on the basis of the assumed section and span layout, to calculate design stress and thereby judge the assumed section.

In such a conventional structural calculation program, however, when examination groups are set for all material elements and section elements, respectively, for the purpose of determining an optimal section, there are so many combinations of section and material that it would take much time for processing in addition to much futility. Further more, there is a problem such that practical proportioning process is difficult to be performed when a section of members is simply combined with materials available since the value would be astronomical in the case to be examined, although it is possible to set a section reasonably and at a low cost by decreasing an area of a section of a member gradually toward the top floor and using a material with lesser strength toward the upper floor, due to the smaller design stress.

### SUMMARY OF THE INVENTION

In view of the above situation, the invention is intended to provide an optimal section setting program capable of setting in a short time and with accuracy an optimal section having a desired strength at the minimum cost without depending on skill of a designer.

An optimal section setting program in a first aspect of the invention controls a computer to perform: an initial value setting step for selecting on the basis of an outline and design specification of an inputted building as initial values basic materials and basic sections of the lowest floors and those of the highest floors in a similar building whose materials and sections are stored in the database in advance; a vertical group setting step for setting between the lowest floor and the highest floor a plurality of vertical groups including one or more floors in which materials and sections are identical, on the basis of the above design specification and the selected initial values; a vertical variation step for setting a plurality of examination groups of combinations of plural classes of sections and materials for each of the set vertical group so that the sections and the materials of the lowest and highest floors set at the initial value setting step would be changed at a certain ratio; a structural calculation step for carrying out structural calculation for each of the plural examination groups obtained on the basis of the initial values at the vertical variation step; a cost calculation step for calculating a cost of the examination groups, making reference to a unit price database, after carrying out quantity calculation on the basis of the above sections and materials of the examination groups; and a minimum cost determining step for selecting a minimum cost by comparing results of the calculation at the cost calculation step.

In the program in a second aspect of the invention, at the initial value setting step, in addition to basic materials and basic sections of the lowest floor and materials and sections of the highest floor, materials and sections one class higher and/or lower than the above are selected as the upper limit and/or the lower limit so as to be set as initial values while the above vertical group setting step and the following steps are repeated on the basis of the initial values to select the above minimum cost.

In the program in a third aspect of the invention, the vertical variation step according to the first or second aspect of the invention includes: a first step for setting a plurality of examination cases in which the above sections are identical/different and the materials are identical/different among vertical groups; and a second step for setting a plurality of examination groups of combinations of plural classes of section and material for each of the plural examination cases so that the sections and the materials between the lowest floor and the highest floor would be changed at a certain ratio.

Further, the program in a fourth aspect of the invention comprises a vertical group judging step for judging a margin of a section in the vertical group on the basis of the result at the minimum cost determining step so that the vertical group would be reset at the vertical group setting step when the margin exceeds a reference, and thereby, the vertical variation step and the following steps would be repeated according to the first to third aspects of the invention.

In the program in a fifth aspect of the invention, the section according to any one of the first to fourth aspects of the invention is a section of a column, a girder and an earthquake resisting wall, and the material is concrete, a main reinforcement and a shear reinforcement.

### BRIEF DESCRIPTION OF THE DRAWINGS

Other features and advantages of the present invention will appear more clearly upon reading the following detailed description, made with reference to the annexed drawings in which:

FIG. 1 is a flowchart showing an embodiment of an optimal section setting program according to the invention;

FIG. 2 is a simplified diagram illustrating an example of combinations of identification and difference of sections and profiles in a vertical group setting step shown in FIG. 1; and

FIG. 3 is a simplified diagram illustrating an example of a plurality of examination groups set in a vertical variation step.

### PREFERRED EMBODIMENTS OF THE INVENTION

An embodiment of an optimal section setting program according to the invention will be described hereinafter, made reference to the drawings.

A computer (hardware) for carrying out an optimal section setting program is a well-known personal computer in which a CPU (a main controlling portion) for inclusively controlling the entire computer is connected to a storing unit (RAM), an inputting unit such as a keyboard and a mouse through an input/output controlling portion, a monitor for displaying an input/output data, a driving unit of a storing medium such as a hard disc and a CD-ROM in which the above program or database is stored, and an output unit (not shown) for outputting a result of proportioning such as a printer.

The above program is to set optimal sections of a building, that is, optimal sections of columns, girders and earthquake resisting walls and optimal materials used for such columns and girders. Specifically, the sections to be set are those of columns, width and length of girders and thickness of earthquake resisting walls, while the materials to be set are the class of concrete, main reinforcement and shear reinforcement.

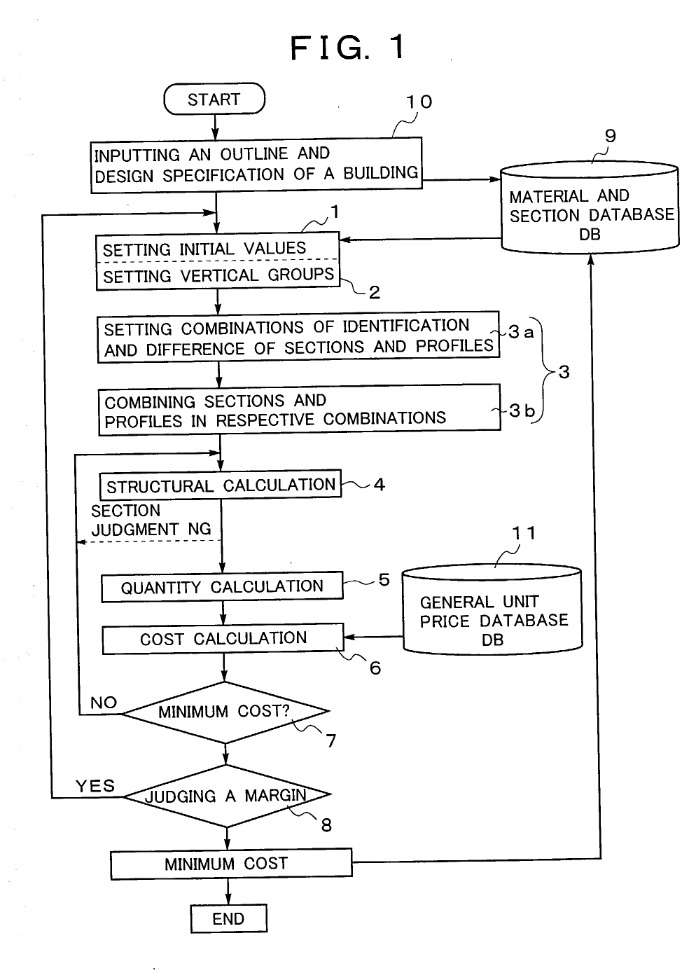

The above program is stored in a storing medium such as the above-mentioned hard disc or a CD-ROM and arranged so as to control the above computer to carry out a initial value setting step 1, a vertical group setting step 2, a vertical variation step 3, a structural calculation step 4, a quantity calculation step 5, a cost calculation step 6, a minimum cost determining step 7 and a margin judging step 8, which comprises a vertical group judging step and a minimum cost judging step, as shown in the flowchart of FIG. 1.

The vertical variation step 3 includes a first step 3a for setting combinations of identical/different sections and profiles among vertical groups and a second step 3b for further setting combinations of plural classes of section and material for each of the former combination.

Now, a process of the program will be described in accordance with the flowchart of FIG. 1. First, various conditions for designing an outline of construction method, floor planning, use, floor area, floor number and floor height, and horizontal force for design of a building whose sections are to be set are inputted at an inputting step 10. Then, basic materials and basic sections of the lowest floor and materials and sections of the highest floor in a building having a building outline and design specification similar to those of the former building are selected from data of buildings having been constructed before, the data which is stored in advance in a material and section database 9, on the basis of the above inputted outline and the design specification of the building. Materials and sections one class higher and lower than those selected are also selected. The above selected condition is set as an initial value group i at the initial value setting step 1.

Selecting materials and sections one class higher and lower than those selected means that, for example, Fc 42 and 30 N/mm² of concrete belonging to classes immediately next to a class of basic concrete are selected when Fc 36 N/mm² of concrete is selected as the basic material; and that 800 mm×800 mm and 700 mm×700 mm of column sections belonging to classes immediately next to a class of a basic section are selected when 750 mm×750 mm of column section is selected as the basic section. In this case, only materials and sections one class higher or lower than those set in advance are selected when there are no lower or higher class of materials and sections set in advance.

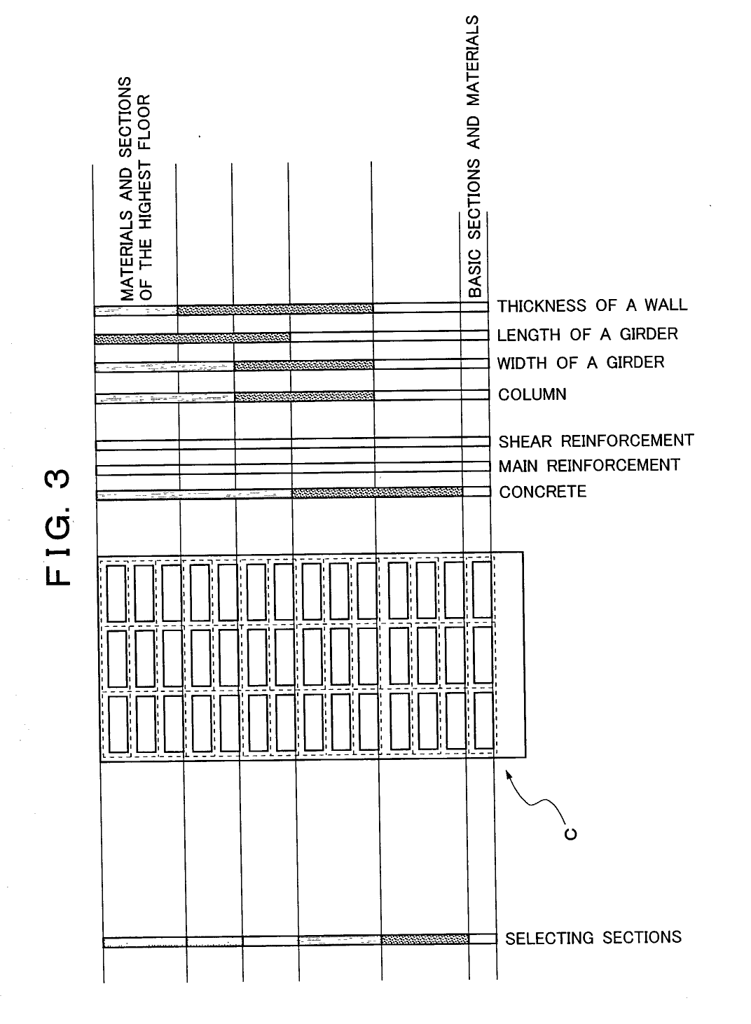

Next, a plurality of vertical groups normally comprising 2 to 4 floors are set between the lowest floor and the highest floor on the basis of the inputted design specification and the selected initial value at the vertical group setting step 2. Materials and sections are considered to be identical in each vertical group at the steps that will follow. As an example, six groups are set between the lowest floor and the highest floor in a building C (shown in FIG. 3) and Table 1 described later.

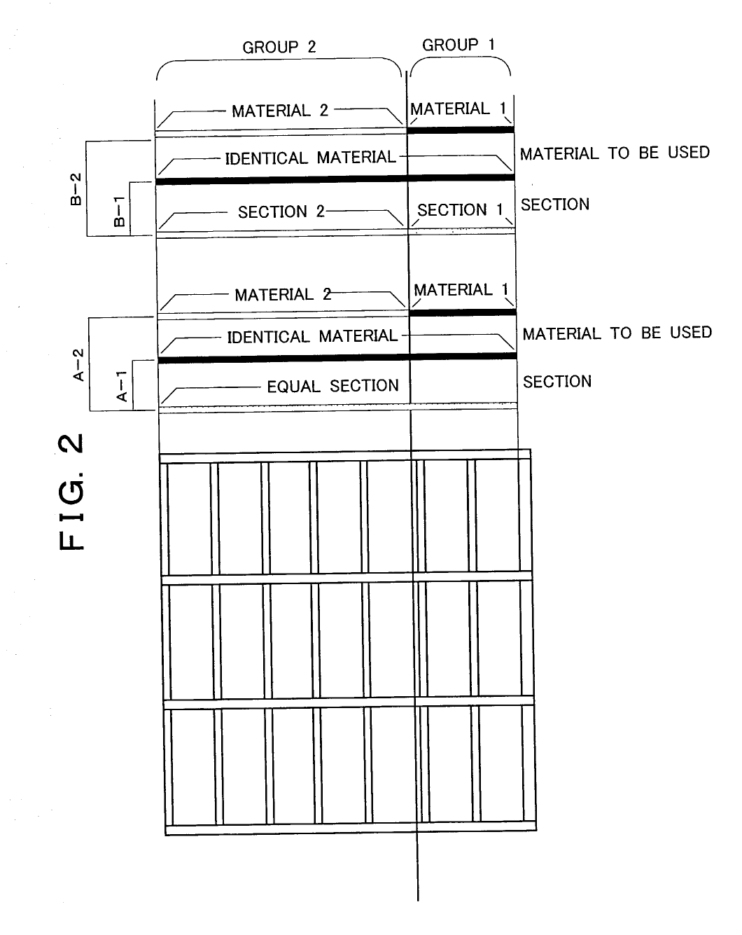

In the vertical variation step 3, a plurality of examination groups of combinations of plural sections and plural materials are set for each vertical group set at the vertical group setting step 2 so that the initial values of sections and materials between the lowest floor and the highest floor, which have been set at the initial value setting step 1, would be changed at a certain ratio. That is, at the first step 3a, a plurality of examination cases are set such as an examination case in which sections and materials are identical among the vertical groups; an examination case in which sections are identical while materials are different; an examination case in which sections are different while material are identical; and an examination case in which both of sections and materials are different, as shown in FIG. 2.

At the second step 3b, a plurality of examination groups of combinations of section elements (a section of a column, width and length of a girder and thickness of a wall) and material elements (the class of concrete, main reinforcements and shear reinforcement) are set for the plural examination cases set in the first step 3a so that sections and materials between the lowest floor and the highest floor would be changed at a certain ratio. Setting at the vertical variation step 3 comprising the first and second steps 3a and 3b is performed in order from the lowest floor to the highest floor of the building. FIG. 3 and Table 1 show an example of one of the plural examination groups set at the vertical variation step 3, wherein Table 1 shows difference between section elements and material elements corresponding to the example shown in FIG. 3. Respective values of material elements and section elements in Table 4 show the respective classes of the elements.

The plural examination groups relating to sections and materials between the lowest floor and the highest floor are thus set for the initial value group i.

Then, structural calculation is carried out for individual examination group in turn at the structural calculation step 4. Subsequent steps are not performed for a combination where a section is judged unsuitable and next structural calculation is carried out instead. Quantity calculation is then performed on the basis of sections and materials of respective examination groups at the quantity calculation step 5. At the subsequent cost calculation step 6, a cost for an examination group corresponding to a result of each quantity calculation is calculated, made reference to a general unit price database 11 including a unit price of materials and wages.

The operations from the structural calculation step 4 to the cost calculation step 6 described above are repeated for all the examination groups. The calculated costs are in turn compared in the minimum cost determining step 7 to determine an examination case with the minimum cost for the initial values. After determining the minimum cost, a margin for the examination group is judged at the margin judging step 8.

The margin judging step 8 includes a vertical group judging step for judging a margin in a vertical group and a minimum cost judging step for judging a margin of a section with the minimum cost in the initial value group i set in advance.

The margin judging step 8 in a vertical group will be described hereinafter. As described above, materials and sections are considered to be identical in each vertical group. Selection of a section of respective members in a vertical group is carried out for all floors included in the vertical group to select a section with the maximum amount of arranged reinforcement as a determined section in the vertical group. It is required to further ramify the vertical group when the difference between the maximum and minimum amounts of arranged reinforcements of sections in each floor is large.

Accordingly, an examined value (=design stress/resistance of a selected member) is calculated for main reinforcements and shear reinforcements in each floor in a certain vertical group, for example, and then, when the difference between the maximum and minimum values and/or the examined value accords with a judging standard set in advance (for example, the difference is 0.1 or more and/or the examined value is less than 0.9), it is judged that the initial grouping at the vertical group setting step 2 is not appropriate, so that the process would go back to the vertical group setting step 2 to repeat the above steps after resetting.

In the minimum cost judging step, the above-mentioned margin is judged for the case of the minimum cost selected from the initial value group i. When it is judged that either the section elements or the material elements have a margin, the process goes back to the initial value setting step 1 to reset the section elements or the material elements having a margin at an initial value group i+1, which is one class lower than that of the above case, and repeats the following steps. The margin judging step 8 is repeated until it is judged that there is no margin for materials and sections, which therefore performs the minimum cost.

Data of an optimal section, which is obtained relating to a building in question, is stored in the database 10 together with data of an outline and design specification of the building so as to be used as data necessary in setting an optimal section of a next building.

As described above, in accordance with the above optimal section setting program, basic materials and basic sections of the lowest floor and materials and sections of the highest floor in a similar building or buildings, whose materials and sections are stored in the database in advance, are selected as initial values to set a plurality of examination groups of combinations of plural sections and plural materials so that the sections and the materials of the lowest and highest floors would be changed at a certain ratio for the corresponding initial values. After the structural calculation for each of the above plural examination groups is completed, cost calculation is continuously carried out while the calculated results are compared with each other to determine the minimum cost. Therefore, a section of a column, a girder, and an earthquake resisting wall having desired strength at the minimum cost can be set in a short time and with accuracy without depending on skill of a designer.

In addition, planning and section setting reasonable in respect of a construction cost can be performed in consideration of a unit price of materials in market by properly renewing the general unit price database 11 since the unit price of a material element changes in accordance with the time passing. Moreover, it is also possible to reduce the structural quantity and cost.

Especially in the optimal section setting program, in addition to basic materials and basic sections of the lowest floor and materials and sections of the highest floor, materials and sections one class higher and/or lower than the above are set as the upper limit and/or the lower limit so as, to be set as initial values at the initial value setting step 1. The steps from the vertical group setting step 2 are repeated in respect of the initial value so as to determine the minimum cost. Therefore, it is possible to certainly set a reasonable optimal section in a short time.

Furthermore, a margin of a section in a vertical group is judged at the margin judging step 8 in respect of results of the minimum cost determining step 7. When a margin is judged to exceed the standard, the vertical groups are reset at the vertical group setting step 2. Therefore, it is possible to set a fine and reasonable optimal section from the lowest floor to the highest floor.

In addition, when it is judged at the minimum cost judging step in the margin judging step 8 that there is a margin in the case of the minimum cost selected from the initial value group i, the process goes back to the initial value setting step 1 to reset section elements or material elements one class lower than those having a margin at an initial value group i+1, and then, repeats the following steps as well as the above. Therefore, an error of the initial values can be certainly corrected, so that an optimal section can be set, even when the corresponding data of the past cases is insufficient in the database 9.

In the above embodiment, only the case is described that the class of concrete, main reinforcements and shear reinforcements, sections of columns, width and length of girders and thickness of earthquake resisting walls are selected as material elements and section elements for determining an optimal section. The invention, however, is not limited to the above embodiment, in which one or more elements may be omitted or other material elements or section elements may be added so as to set an optimal section.

As described above, in accordance with an optimal section setting program according to the invention, it is possible to set with accuracy and in a short time an optimal section having desired strength at the minimum cost without depending on skill of a designer, as well as to perform planning and section setting reasonable in respect of a construction cost in consideration of a unit price of materials in market, so that the structural quantity and a cost can be reduced.

Especially, according to the second aspect of the invention, in addition to basic materials and basic sections of the lowest floor and materials and sections of the highest floor, the basic materials, the basic sections, the materials and the sections which are selected from the database, materials and sections one class higher and/or lower than the above are selected as the upper limit and/or the lower limit so as to be set as initial values, so that a reasonable optimal section can be certainly set in a short time. Further, according to the third aspect of the invention, it is possible to examine combinations of various elements necessary to set an optimal section. Moreover, according to the fourth aspect of the invention, there is an effect that a fine and reasonable optimal section can be set from the lowest floor to the highest floor.

TABLE 1

| | | | | MAIN | | | | | |
|---|---|---|---|---|---|---|---|---|---|
| | | | | REIN- | SHEAR | | | | |
| | | SELECTING | | FORCE- | REINFORCE- | SECTION OF | WIDTH OF | LENGTH OF | THICKNESS |
| CLASS | GROUPING | SECTIONS | CONCRETE | MENT | MENT | COLUMNS | GIRDERS | GIRDERS | OF WALLS |
| 13-14 | 6 | 6 | 3 | 1 | 1 | 3 | 3 | 2 | 3 |
| 11-12 | 5 | 5 | 3 | 1 | 1 | 3 | 3 | 2 | 2 |
| 8-10 | 4 | 4 | 3 | 1 | 1 | 2 | 2 | 2 | 2 |
| 5-7 | 3 | 3 | 2 | 1 | 1 | 2 | 2 | 1 | 2 |
| 2-4 | 2 | 2 | 2 | 1 | 1 | 1 | 1 | 1 | 1 |
| 1 | 1 | 1 | 1 | 1 | 1 | 1 | 1 | 1 | 1 |

What is claimed is:

1. An optimal section setting program for controlling a computer to perform:
an initial value setting step for selecting on the basis of an outline and design specification of an inputted building as initial values basic materials and basic sections of the lowest floors and materials and sections of the highest floors in a similar building whose materials and sections are stored in the database in advance;
a vertical group setting step for setting between the lowest floor and the highest floor a plurality of vertical groups including one or more floors in which materials and sections are identical, on the basis of the above design specification and the selected initial values;
a vertical variation step for setting a plurality of examination groups of combinations of plural classes of sections and materials for each of the set vertical groups so that the sections and the materials of the lowest and highest floors set at the initial value setting step would be changed at a certain ratio;
a structural calculation step for carrying out structural calculation for each of the plural examination groups obtained on the basis of the initial values at the vertical variation step;
a cost calculation step for calculating a cost of the examination groups, making reference to a unit price database, after carrying out quantity calculation on the basis of the above sections and materials of the examination groups; and
a minimum cost determining step for selecting a minimum cost by comparing results of the calculations at the cost calculation step.

2. The optimal section setting program according to claim 1, wherein, at the above initial value setting step, in addition to basic materials and basic sections of the lowest floor and materials and sections of the highest floor, materials and sections one class higher and/or lower than the above are selected as the upper limit and/or the lower limit so as to be set as initial values while the above vertical group setting step and the following steps are repeated on the basis of the initial values to select the above minimum cost.

3. The optimal section setting program according to claim 1 or 2, wherein the vertical variation step includes: a first step for setting a plurality of examination cases in which the above sections are identical and different and the materials are identical and different among the vertical groups; and a second step for setting a plurality of examination groups of combinations of plural classes of section and material for each of the plural examination cases so that the sections and the materials between the lowest floor and the highest floor would be changed at a certain ratio.

4. The optimal section setting program according to any one of claims 1 to 3, further comprising a vertical group judging step for judging a margin of a section in the vertical group on the basis of the result at the minimum cost determining step so that the vertical group would be reset at the vertical group setting step when the margin exceeds a reference, and thereby, the vertical variation step and the following steps would be repeated.

5. The optimal section setting program according to any one of claims 1 to 4, wherein the section is a section of a column, a girder and an earthquake resisting wall while the material is concrete, a main reinforcement and a shear reinforcement.
